(19) United States
(12) Patent Application Publication
(10) Pub. No.: US 2016/0039042 A1
(43) Pub. Date: Feb. 11, 2016

(54) Method for Friction Welding Subsea Flowline Connectors

(71) Applicants: David RIGGS, (US); Jovica PETROVIC, (US); Colin Raymond NICHOLLS, (US)

(72) Inventors: David RIGGS, Houston, TX (US); Jovica PETROVIC, Halesowen (GB); Colin Raymond NICHOLLS, Halesowen (GB)

(21) Appl. No.: 14/775,505

(22) PCT Filed: Mar. 14, 2014
(86) PCT No.: PCT/US14/27942

§ 371 Date: Sep. 11, 2015

Related U.S. Application Data
(60) Provisional application No. 61/782,095, filed on Mar. 14, 2013.

(51) Int. Cl. B23K 20/12; F16L 1/26; F16L 58/18; B23K 20/22

(52) U.S. Cl. CPC B23K 20/129; B23K 20/22; F16L 1/26; F16L 58/182; F16L 58/181; B23K 2203/18

(57) ABSTRACT

Methods of rotary friction welding a (e.g., concentrically) threaded connector to a subsea-type riser or flowline pipe segment and/or of rotary friction welding cladded pipe segments. Subsea-type riser or flowline pipe segment with a (e.g., concentrically) threaded connector fused to the pipe segment at an autogeneous friction welded seam, and/or subsea-type riser or flowline cladded pipe segments fused together at a friction welded seam.

### CROSS-REFERENCE TO RELATED APPLICATION

This application claims the benefit of priority to U.S. Provisional Patent Application No. 61/782,095 filed Mar. 14, 2013, the contents of which are incorporated by reference in their entirety.

### BACKGROUND

1. Field of the Invention

The present invention relates generally to subsea flowline and riser pipers. More particularly, but not by way of limitation, the present invention relates to subsea flowline and riser pipes with friction-welded connectors.

2. Description of Related Art

Pipe strings consisting of many pipe sections connected in tandem, are widely used in the sea to transfer crude oil and other hydrocarbons between the sea floor and a floating body, or between floating bodies. One common type of pipe string includes multiple steel pipe sections, each of a length such as 10 meters, that are connected together. For example, pipe sections were traditionally been welded together. More recently, pipe sections may be connected to one another by threaded connectors at the ends of each section of pipe, with such connectors unitary with the pipe (e.g., machined with or into the pipe) or coupled to the pipe via conventional welding techniques. Such threaded connectors may be helically threated (include helical threads) or concentrically threaded (include axially-spaced circular threads).

Concentrically threaded connectors have been machined into tubular members (e.g., pipe segments) or welded to tubular members by means of conventional welding techniques. Such techniques typically utilize dissimilar weld filler materials and require melting of filler and adjacent base materials. As the filler and base materials exceed their liquid states, subsequent cooling and freezing of the weld zone produces a cast structure. Such cast structures usually contain porosity and shrinkage defects, and in the case of crystalline materials, often contain a dendritic structure which is less ductile and of lower strength than a forged structure.

### SUMMARY

This disclosure includes embodiments of methods and apparatuses related to rotary friction welding threaded connectors to subsea-type riser and flowline pipe segments.

Some embodiments of the present methods comprise: rotary friction welding a threaded first connector to an undersea-type riser or flowline pipe segment. In some embodiments, the rotary friction welding comprises: rotating the first connector in contact with the pipe segment until a portion of the first connector reaches a plastic state and a portion of the pipe segment reaches a plastic state; and pressing the first connector and the pipe segment together until the first connector and pipe segment have fused together. In some embodiments, the connector and the pipe segment are pressed together at a pressure of between 14,000 pounds per square inch (psi) and 60,000 psi. In some embodiments, portions of the connector and the pipe segment reach temperatures of between 900° C. and 1100° C. during the rotary friction welding. In some embodiments, at least a portion of the pressing is simultaneous with at least a portion of the rotating. In some embodiments, the first connector is concentrically threaded. In some embodiments, the first connector is configured to be joined with a second connector by forcing the first and second connectors together without rotation along a common longitudinal axis. In some embodiments, the first connector includes an annular pipe mating surface, and the pipe includes an annular connector mating surface configured to mate with the pipe mating surface of the first connector. In some embodiments, the pipe has an outer diameter of 6 inches or greater (e.g., 8 inches or greater, 12 inches or greater). In some embodiments, during the rotary friction welding, rotation of the connector is driven by a powered motor. In some embodiments, during the rotary friction welding, the connector is driven by the inertia of a flywheel. In some embodiments, the rotary friction welding comprises: applying a force to accelerate the flywheel to a velocity at which the flywheel has sufficient kinetic energy to rotate the first connector to fuse the connector to the pipe; removing the force from the flywheel; and pressing the connector and the pipe together as the connector is rotated by the flywheel until the rotation stops and the connector is fused to the pipe.

In some embodiments of the present methods, the pipe segment comprises a primary metal and an interior of the pipe segment is clad with a layer of corrosion resistant alloy (CRA) or other metal that is different than the primary metal. In some embodiments, the interior cladding layer is mechanically coupled to the primary metal. In some embodiments, the interior cladding layer is metallurgically coupled to the primary metal. In some embodiments, a thickness of the interior cladding layer of the pipe segment is between 0.05 inches and 0.25 inches. In some embodiments, the connector comprises a primary metal and an interior of the connector is clad with a layer of corrosion resistant alloy (CRA) or other metal. In some embodiments, an extruded flash on an interior of the pipe after friction welding has a hardness of less than Rockwell Hardness Rc 30. In some embodiments, an end surface of the primary metal is clad with a layer of corrosion resistant alloy (CRA) or other metal that is different than the primary metal. In some embodiments, the thickness of the end cladding layer is between 0.25 inches and 0.5 inches. In some embodiments, a first faying surface is defined by the primary metal and interior cladding layer of the pipe segment, and the first faying surface is not entirely square. In some embodiments, the primary metal extends beyond the interior cladding layer at an end profile of the pipe segment. In some embodiments, the interior cladding layer extends beyond the primary metal at an end profile of the pipe segment. In some embodiments, at least a portion of the primary metal angles longitudinally outward and radially outward from the interior cladding layer at an end profile of the pipe segment. In some embodiments, a portion of the primary metal angles longitudinally inward and radially outward from the interior cladding layer at an end profile of the pipe segment. In some embodiments, the primary metal angles longitudinally inward and radially outward from the interior cladding layer at an end profile of the pipe segment.

Some embodiments of the preset methods further comprise: rotary friction welding a second undersea-type riser or flowline pipe segment to the first pipe segment; where the second pipe segment comprises a primary metal and an interior of the second pipe segment is clad with a layer of corrosion resistant alloy (CRA) or other metal that is different than the primary metal. Some embodiments further comprise: rotary friction welding a threaded second connector to the second pipe segment. Some embodiments further comprise: rotary friction welding a third undersea-type riser or flowline pipe segment to the second pipe segment; where the second pipe segment comprises a primary metal and an interior of the third pipe segment is clad with a layer of corrosion resistant alloy (CRA) or other metal that is different than the primary metal. Some embodiments further comprise: rotary friction welding a threaded second connector to the third pipe segment. Some embodiments further comprise: rotary friction welding a fourth undersea-type riser or flowline pipe segment to the third pipe segment; where the fourth pipe segment comprises a primary metal and an interior of the fourth pipe segment is clad with a layer of corrosion resistant alloy (CRA) or other metal that is different than the primary metal. Some embodiments further comprise: rotary friction welding a threaded second connector to the fourth pipe segment. In some embodiments, where the rotary friction welding occurs on-shore before shipping the assembly to an off-shore location.

Some embodiments of the present apparatuses comprise: a length of undersea-type riser or flowline pipe having a first end; a threaded connector fused to the first end at an autogeneous friction welded seam. In some embodiments, the first connector is concentrically threaded. In some embodiments, the first connector is configured to be joined with a second connector by forcing the first and second connectors together without rotation along a common longitudinal axis. In some embodiments, the pipe has an outer diameter of 6 inches or greater (e.g., 8 inches or greater, 12 inches or greater).

In some embodiments of the present apparatuses, the pipe segment comprises a primary metal and an interior of the pipe segment is clad with a layer of corrosion resistant alloy (CRA) or other metal that is different than the primary metal. In some embodiments, the interior cladding layer is mechanically coupled to the primary metal. In some embodiments, the interior cladding layer is metallurgically coupled to the primary metal. In some embodiments, a thickness of the interior cladding layer of the pipe segment is between 0.05 inches and 0.25 inches. In some embodiments, the connector comprises a primary metal and an interior of the connector is clad with a layer of corrosion resistant alloy (CRA) or other metal. In some embodiments, the friction weld comprises a corrosion resistant alloy (CRA) or other metal that is different than the primary metal.

Some embodiments of the present apparatuses further comprise: a second undersea-type riser or flowline pipe segment fused to the first pipe segment fused at an autogeneous friction welded seam; where the second pipe segment comprises a primary metal and an interior of the second pipe segment is clad with a layer of corrosion resistant alloy (CRA) or other metal that is different than the primary metal. Some embodiments further comprise: a threaded second connector fused to the second pipe segment at an autogeneous friction welded seam. Some embodiments further comprise: a third undersea-type riser or flowline pipe segment fused to the second pipe segment fused at an autogeneous friction welded seam; where the third pipe segment comprises a primary metal and an interior of the second pipe segment is clad with a layer of corrosion resistant alloy (CRA) or other metal that is different than the primary metal. Some embodiments further comprise: a threaded second connector fused to the third pipe segment at an autogeneous friction welded seam. Some embodiments further comprise: a fourth undersea-type riser or flowline pipe segment fused to the second pipe segment fused at an autogeneous friction welded seam; where the fourth pipe segment comprises a primary metal and an interior of the second pipe segment is clad with a layer of corrosion resistant alloy (CRA) or other metal that is different than the primary metal. Some embodiments further comprise: a threaded second connector fused to the fourth pipe segment at an autogeneous friction welded seam.

Some embodiments of the present methods comprise: rotary friction welding a first and second undersea-type riser or flowline pipe segments together; where each of the first and second pipe segments comprises a primary metal and an interior of the respective pipe segment is clad with a layer of corrosion resistant alloy (CRA) or other metal that is different than the primary metal. In some embodiments, the interior cladding layer of at least one of the first and second pipe segments is mechanically coupled to the primary metal. In some embodiments, the interior cladding layer of at least one of the first and second pipe segments is metallurgically coupled to the primary metal. In some embodiments, a thickness of the interior cladding layer of the pipe segment is between 0.05 inches and 0.25 inches. In some embodiments, an extruded flash on an interior of the pipe after friction welding has a hardness of less than Rockwell Hardness Rc 30. In some embodiments, an end surface of the primary metal of at least one of the first and second pipe segments is clad with a layer of corrosion resistant alloy (CRA) or other metal that is different than the primary metal. In some embodiments, the thickness of the end cladding layer is between 0.25 inches and 0.5 inches. In some embodiments, a first faying surface is defined by the primary metal and interior cladding layer of the first pipe segment, a second faying surface is defined by the primary metal and interior cladding layer of the second pipe segment, and each of the first and second faying surfaces is not entirely square. In some embodiments, the primary metal extends beyond the interior cladding layer at an end profile of each of the first and second pipe segment. In some embodiments, the interior cladding layer extends beyond the primary metal at an end profile of each of the first and second pipe segments. In some embodiments, at least a portion of the primary metal angles longitudinally outward and radially outward from the interior cladding layer at an end profile of each of the first and second pipe segments. In some embodiments, a portion of the primary metal angles longitudinally inward and radially outward from the interior cladding layer at an end profile of each of the first and second pipe segments. In some embodiments, the primary metal angles longitudinally inward and radially outward from the interior cladding layer at an end profile of the pipe segment.

In some embodiments of the present methods, the rotary friction welding comprises: rotating the first pipe segment in contact with the second pipe segment until portions of the first and second pipe segments reach a plastic state; and pressing the first and second pipe segments together until the first and second pipe segments have fused together. In some embodiments, the first and second pipe segments are pressed together at a pressure of between 14,000 pounds per square inch (psi) and 60,000 psi. In some embodiments, portions of the connector and the pipe segment reach temperatures of between 900° C. and 1100° C. during the rotary friction welding. In some embodiments, at least a portion of the pressing is simultaneous with at least a portion of the rotating. In some embodiments, the first and second pipe segments each has an outer diameter of 6 inches or greater. In some embodiments, the first and second pipe segments each has an outer diameter of 8 inches or greater. In some embodiments, the first and second pipe segments each has an outer diameter of 12 inches or greater. In some embodiments, during the rotary friction welding, rotation of the first pipe segment is driven by a powered motor. In some embodiments, during the rotary friction welding, rotation of the first pipe segment is driven by the inertia of a flywheel. In some embodiments, the rotary friction welding comprises: applying a force to accelerate the flywheel to a velocity at which the flywheel has sufficient kinetic energy to rotate the first connector to fuse the first pipe segment to the second pipe segment; removing the force from the flywheel; and pressing the first and second pipe segments together as the first pipe segment is rotated by the flywheel until the rotation stops and the first and second pipe segments are fused together.

Some embodiments of the present apparatuses comprise: a first segment of undersea-type riser or flowline pipe having a first end; a second segment of undersea-type riser or flowline pipe having a first end; a threaded connector fused to the first end at an autogeneous friction welded seam. In some embodiments, the first and second pipe segments each has an outer diameter of 6 inches or greater. In some embodiments, the first and second pipe segments each has an outer diameter of 8 inches or greater. In some embodiments, the first and second pipe segments each has an outer diameter of 12 inches or greater. In some embodiments, each of the first and second pipe segments comprises a primary metal and an interior of the respective pipe segment is clad with a layer of corrosion resistant alloy (CRA) or other metal that is different than the primary metal. In some embodiments, the interior cladding layer of each of the first and second pipe segments is mechanically coupled to the primary metal. In some embodiments, the interior cladding layer of each of the first and second pipe segments is metallurgically coupled to the primary metal. In some embodiments, a thickness of the interior cladding layer of each of the first and second pipe segments is between 0.05 inches and 0.25 inches. In some embodiments, the friction weld comprises a corrosion resistant alloy (CRA) or other metal that is different than the primary metal.

Any embodiment of any of the present cables, systems, apparatuses, and methods can consist of or consist essentially of—rather than comprise/include/contain/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

Details associated with the embodiments described above and others are presented below.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers. The figures are drawn to scale for certain embodiments (unless otherwise noted), meaning the sizes of the depicted elements are accurate relative to each other for at least the depicted embodiment.

FIG. 1 depicts a cross-sectional view of a joint portion of a pipe string with male and female connectors coupled to adjacent pipe segments.

FIG. 2 depicts an enlarged cross-sectional view of area 2-2 of FIG. 1.

FIG. 3 depicts an enlarged cross-sectional view of area 3-3 of FIG. 1.

FIG. 4 depicts a cross-sectional view of a first embodiment of a female connector adjacent to a first embodiment of a pipe segment.

FIG. 5 depicts a cross-sectional view of a the female connector and pipe segment of FIG. 4 after having been joined by friction welding.

FIG. 6 depicts a block diagram of an embodiment of an apparatus for rotary friction welding a connector to a second a subsea-type flowline or riser pipe segment.

FIGS. 7A-7B depict a cross-sectional view of a second embodiment of a cladded female connector and a segment of cladded pipe, before and after having been joined by friction welding.

FIGS. 8A-8B depict a cross-sectional view of a third embodiment of a cladded female connector and a segment of cladded pipe, before and after having been joined by friction welding.

FIGS. 9A-9B depict cross-sectional views of a fourth embodiment of two segments of cladded pipe, before and after having been joined by friction welding.

FIGS. 10A-10B depict cross-sectional views of a fifth embodiment of two segments of cladded pipe, before and after having been joined by friction welding.

FIGS. 11-16 depict cutaway cross-sectional views of various configurations of faying surfaces suitable for at least some of the present embodiments.

FIG. 17 depicts a cutaway cross-sectional view of a friction weld after joining and under an axial load while still hot to allow machining to remove excess material.

### DESCRIPTION OF ILLUSTRATIVE EMBODIMENTS

The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed embodiment, the terms “substantially,” “approximately,” and “about” may be substituted with “within [a percentage] of” what is specified, where the percentage includes 0.1, 1, 5, and 10 percent.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system or apparatus that “comprises,” “has,” “includes” or “contains” one or more elements possesses those one or more elements, but is not limited to possessing only those elements. Likewise, a method that “comprises,” “has,” “includes” or “contains” one or more steps possesses those one or more steps, but is not limited to possessing only those one or more steps.

Further, a structure (e.g., a component of an apparatus) that is configured in a certain way is configured in at least that way, but it can also be configured in other ways than those specifically described.

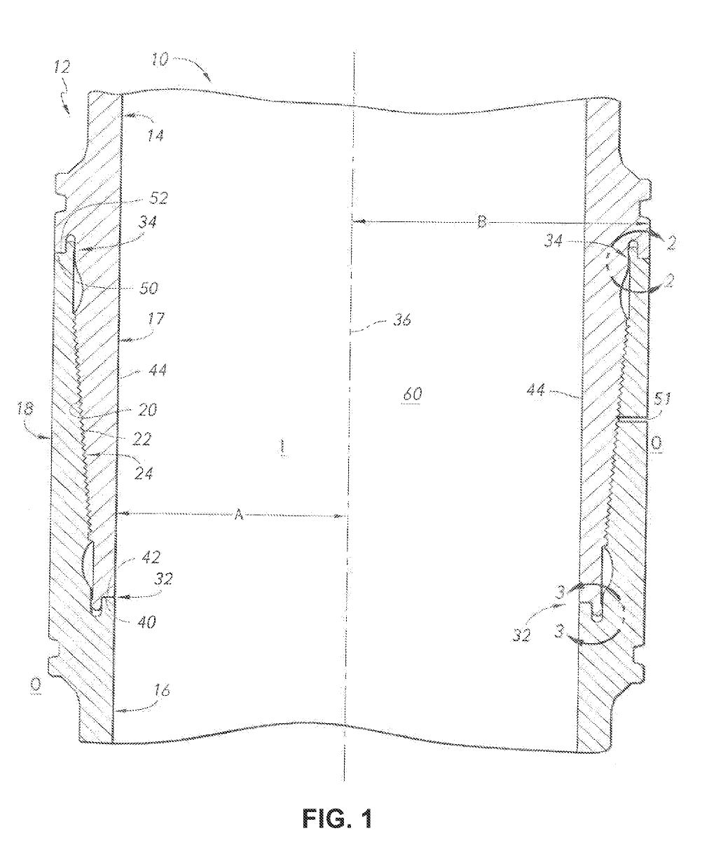

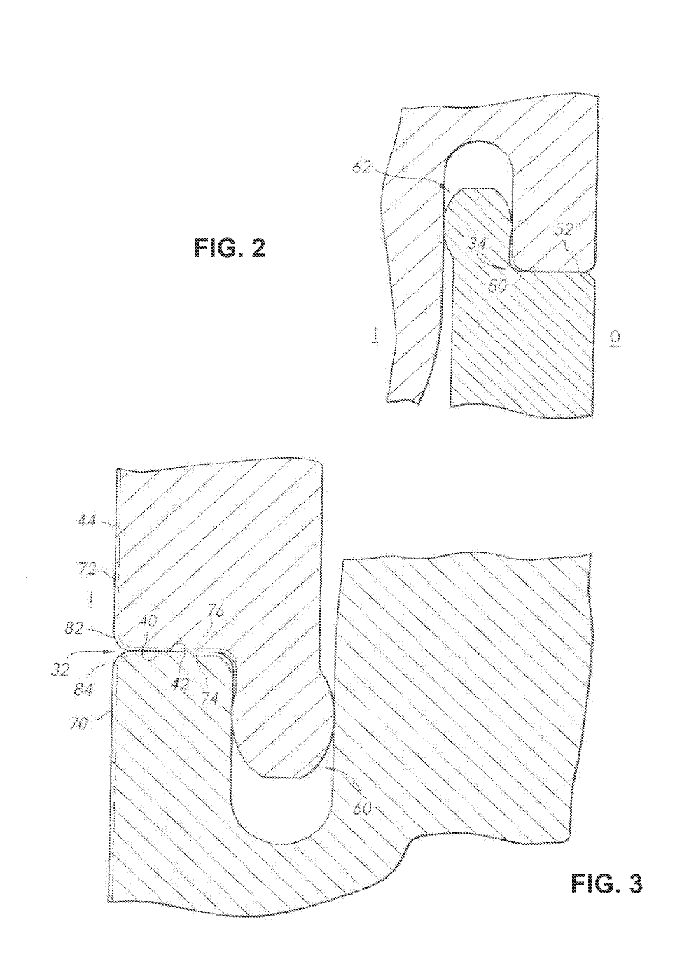

FIG. 1 depicts an example of concentrically threaded, axial-makeup (in which male and female connectors are configured to be joined by being forced together without rotation along a common longitudinal axis (36)) male and female connectors that may be used to connect adjacent pipe segments in a subsea flowline or riser pipe string 10. For example, a pipe string can include many steel pipe sections (e.g., each of a length such as, for example, 30 meters), which are threadably connected in tandem. In the embodiment shown, each connector is concentrically threaded with axially-spaced (relative to the pipe axis) circular threads that lie on an imaginary cone. While certain details of the connector are described in this disclosure, additional details and variations are disclosed in U.S. patent application Ser. No. 13/013,739, filed Jan. 25, 2011 (published as US 2011/022738), which is incorporated by reference to the extend it discloses features of the connector depicted in FIG. 1 and variations thereof.

FIG. 1 shows a pipe joint 12 where adjacent end portions or connectors 17, 18 of two pipe segments 14, 16 are connected. As shown, connector 17 is a male connector and connector 18 is a female connector. The joint includes threads 20 and 22 on the two pipe sections that form a threaded connection 24. Threads 20 and 22 are engaged with one another and tightened by pressing the two pipe ends together at sealing surfaces 40, 42, 50, 52 that lie at axially (A) opposite joint ends 33, 34. To minimize thread chafing during a threadable connection, the depicted embodiment includes a port 51 in the radially outer (relative to axis 36) pipe end or female connector 18. The joint can be pressurized by a fluid (liquid or gas) directed through the port 51, which radially compresses inner pipe end or male connector 17 and radially expands outer pipe end or female connector 18, thereby easing the threads 20, 22 over one another.

Joint end 32 has upper and lower abutments, or sealing surfaces 40, 42 that both lie at the inside I of the pipeline. Joint end 34, which is shown located at the upper end of the joint 12, has radially outer (with respect to the axis 36) sealing surfaces. Of the two joint ends 32, 34, usually only one, which is the upper and outer abutment location 34 has its abutment faces 50, 52 forcefully abutting one another when the threads are fully tightened. It would require extremely close dimensional tolerances (e.g. less than about 0.02 mm, or 0.001 inch) to assure forceful abutment of the abutment surfaces at both joint ends 32, 34. To manufacture the pipe section ends to these tolerances would be difficult and costly.

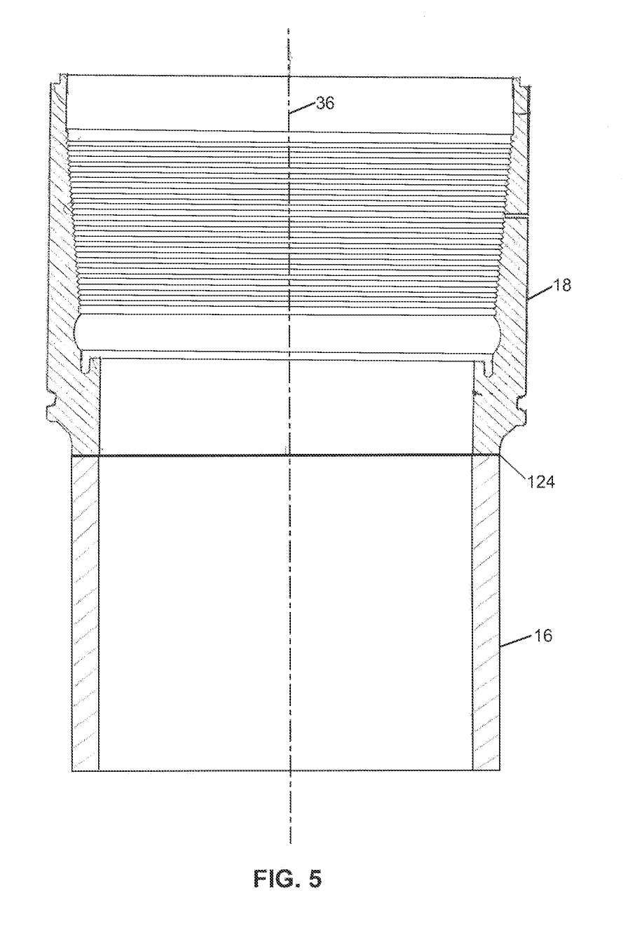

In the embodiment shown, inner sealing surfaces 40, 42 and outer sealing surfaces 50, 52 can be forced to abut one another and form a fluid seal that substantially prevents the ingress and/or egress of fluids. This interface between inner sealing surfaces 40, 42 and outer sealing surfaces 50, 52 also preloads the connector threads to reduce fatigue stresses and stabilize metal-to-metal seal movement at the pipe joint ends 32, 34 shown in FIG. 5.

The inside I (FIG. 1) of the pipe joint is exposed to fluids 60 lying in the pipe, which may include corrosive chemicals when the pipeline is used to carry a mixture of hydrocarbons and corrosive components such as is often found in crude oil. The outside 0 of the pipe joint may be exposed to seawater or atmospheric conditions.

In recent years, offshore oil production has been conducted in ever deeper waters, with the present maximum depth being about 7000 to 10,000 feet. In such depths, steel pipelines connected to floating production units are usually employed to transport well fluids from the seabed to the sea surface. The high seawater pressure at large depths requires large pipe wall thickness to resist collapse, although the pipe inside diameter must be large enough for economic hydrocarbon production rates. This leads to relatively stiff pipes and high bending stresses, especially where a pipeline hanging in a catenary shape makes contact with the seabed. This bending is repetitive as it is the result of the heave of the surface vessel which is constantly being excited by surface waves. This repetitive bending may lead to pipe fatigue. Such fatigue can be accelerated by the presence of H₂S, C0₂ or other chemicals in the well fluids flowing through these pipes, which can lead to a very limited pipe life. To minimize this chemical effect, a CRA (corrosion resistant alloy) cladding (a type of coating) can be applied, shown in phantom lines at 70, 72 in FIG. 3, on the inside surface 44 of the pipeline, with portions 74, 76 of the cladding lying on the inside sealing surfaces 40, 42. Since the inside joint end 32 is closed during use, the cladding portions 74, 76 at the abutting surfaces need not be thicker than on the rest of the inside of the pipe. The corners 82, 84 between the radially inside surfaces 44 and the sealing surfaces 40, 42 have a large radius of curvature of at least 0.05 inch so the cladding extends over them.

FIG. 1 shows that adjacent pipe end portions or connectors 17, 18 are connected by concentric parallel threads. Steps may be taken to be sure that after the threads 20, 22 are threadably connected, they do not slip by torque applied to one of the pipe end portions relative to the other. For example, the threads may be knurled. In knurling, small grooves are formed by pressing a knurling tool against a location on the threads. The pressure of knurling displaces the material that forms the threads to form depressions separated by slight projections. The displaced material resists turning of threads of pipe ends 32, 34 from turning relative to each other unless a large torque is applied. In some embodiments, knurling of a height H of 0.004 inch and width of 0.030 inch is provided at one side of the threads in a thread groove wall rather than in the cylindrical wall, as described in US 2011/0227338. Relative turning may also be reduced by roughening surfaces that turn relative to each other and that are not part of the threads, such as, for example, by shot peening. However, threads are precisely cut surfaces, and the knurling formed in them is more precise than roughening of a smooth (non-threaded) surfaces.

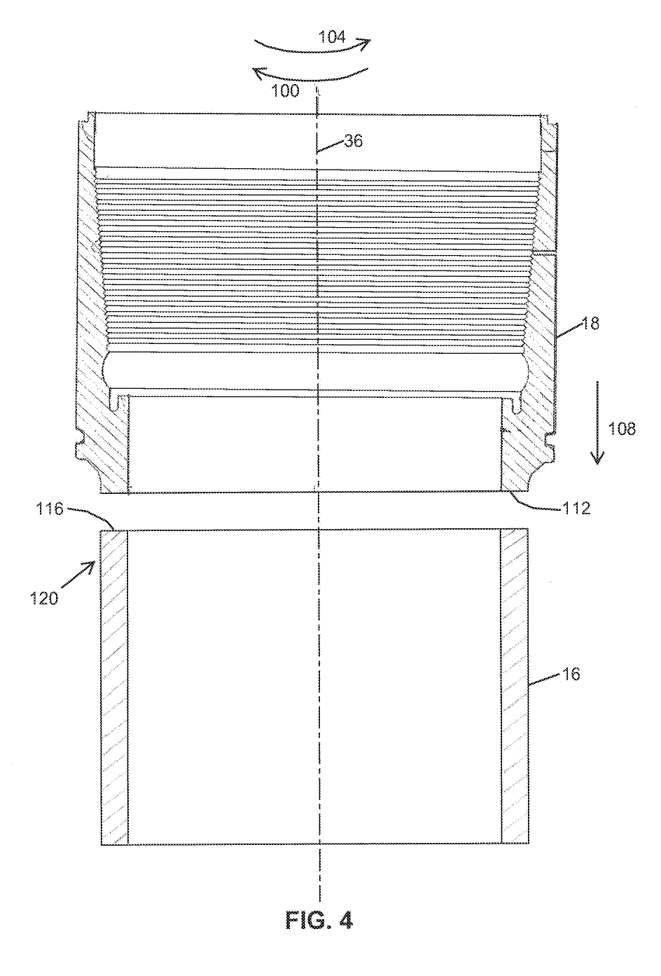

FIG. 4 depicts a cross-sectional view of a first embodiment 18 of a female connector adjacent to a first embodiment 16 of a pipe segment. Although a female connector is shown, the present embodiments are equally applicable and/or include male connectors (e.g., male connector 17). In the embodiment shown, connector 18 is configured to be rotated (e.g., in clockwise direction 100 or counterclockwise direction 104) relative to and in contact with pipe segment 16 while the connector and the pipe are forced together (in direction 108) along a common longitudinal axis 36 to fuse the connector to the pipe segment without melting the connector or the pipe. The present embodiments can include any of various sizes of subsea-type riser or flowline pipes. For example, pipe 16 can have an outer diameter of 6 inches or greater (e.g., 8 inches, 12 inches, 16 inches, 20 inches, 24 inches, 30 inches, 36 inches, or larger) and can have a wall thickness of 0.5 inches or greater (e.g., 0.6 inches, 0.75 inches, 1.0 inch, 1.5 inches, or larger).

In the embodiment shown, connector 18 includes an annular pipe mating surface 112, and pipe segment 16 includes an annular connector mating surface 116 at a first end 120 of the pipe segment. As indicated by its position in FIG. 4, connector mating surface 116 is configured to mate with the pipe mating surface of the connector. In this embodiment, mating surfaces 112 and 116 are each substantially perpendicular to axis 36, as shown. In other embodiments, surfaces 112 and 116 may be beveled or shaped to include a groove or the like to minimize intrusion of material that extrudes into the interior of the pipe and/or outward relative to the pipe.

In some embodiments of the present methods, the connector (18) can be rotated relative to pipe (16) with mating surfaces 112 and 116 in contact with one another under a compressive force (e.g., a first level of force) in direction 108 to polish the mating surfaces (e.g., to remove oxidation and surface irregularities) and heat the adjacent portions of the connector and pipe segment to plastic states. The compressive force in direction 108 between the connector and the pipe segment can be increased (e.g., a second level of force) during rotation to further assist with heating the mating surfaces and adjacent material to a plastic state and/or to extrude material in a plastic state from the seam to ensure complete fusing of the connector to the pipe segment. Once rotation stops, the compressive force in direction 108 may further be increased (e.g., to a third level of force, such as, for example, 150 tons or more (e.g., 150, 200, 250, 300, 350, 400, or more tons) to forge the plastic material at the seam and fully fuse the connector to the pipe segment. With this type of friction welding, a filler or sacrificial material is not needed between the connector and pipe segment, and the resulting seam 124 (FIG. 5) is substantially homogeneous and high in joint strength and efficiency.

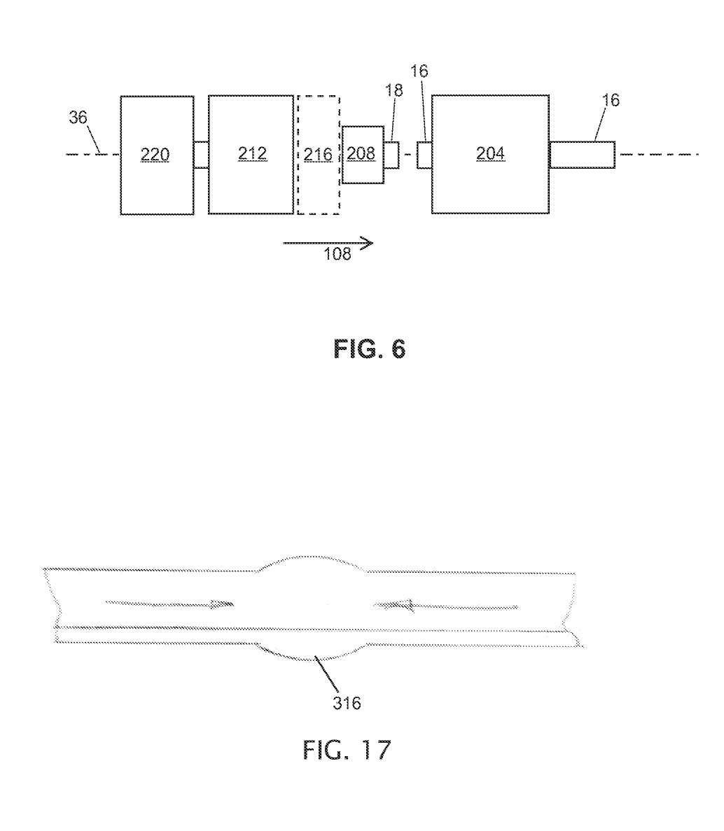

FIG. 6 depicts a block diagram of an embodiment 200 of an apparatus for rotary friction welding a connector to a second a subsea-type flowline or riser pipe segment. In the embodiment shown, apparatus 200 includes a first chuck or clamp 204 configured to hold a pipe segment 18 in a fixed position, a second chuck 208 configured to hold a connector 18, and a powered (e.g., electric, gas, or the like) motor 212 configured to rotate the second chuck or clamp 208. Some embodiments also include a flywheel 216 coupled to second chuck 208 and configured to be rotated by motor 212. In embodiments without flywheel 216, motor 212 provides rotational force to connector 18 continuously during the rotation of connector required for the friction welding process.

In embodiments that include flywheel 216, motor 212 can be configured to accelerate the flywheel to a rotational speed and corresponding kinetic energy (according to the mass of the flywheel) sufficient to rotate the connector and complete the friction welding process. In such embodiments, when the flywheel reaches a sufficient rotational speed, the motor is turned off or disengaged from flywheel 216 such that the flywheel can continue to spin independently of the motor and the inertia of the flywheel can drive rotation of the connector relative to the pipe until portions of the connector and the pipe reach a plastic state and fuse together.

In the embodiment shown, apparatus 200 also includes a press 220 configured to apply a force to chuck 208 in direction 108 to force a connector into a pipe segment during and/or after rotation to fuse the connector and the pipe segment, as described above. In the embodiment shown, motor 212 is movable relative to first chuck or clamp 204 and press 220 is configured to move motor 212 toward first chuck or clamp 204 (e.g., via rails or the like on which the motor is movably mounted). In other embodiments, motor 212 and press 220 can be integral, such that, for example, the driveshaft of the motor can extend to apply the force in direction 108 to chuck 208 while the rest of motor 212 remains stationary. In some embodiments, such as those described below for cladded pipes and/or cladded connectors, the connector and the pipe segment (or two pipe segments) are pressed together at a pressure of between 14,000 pounds per square inch (psi) and 60,000 psi.

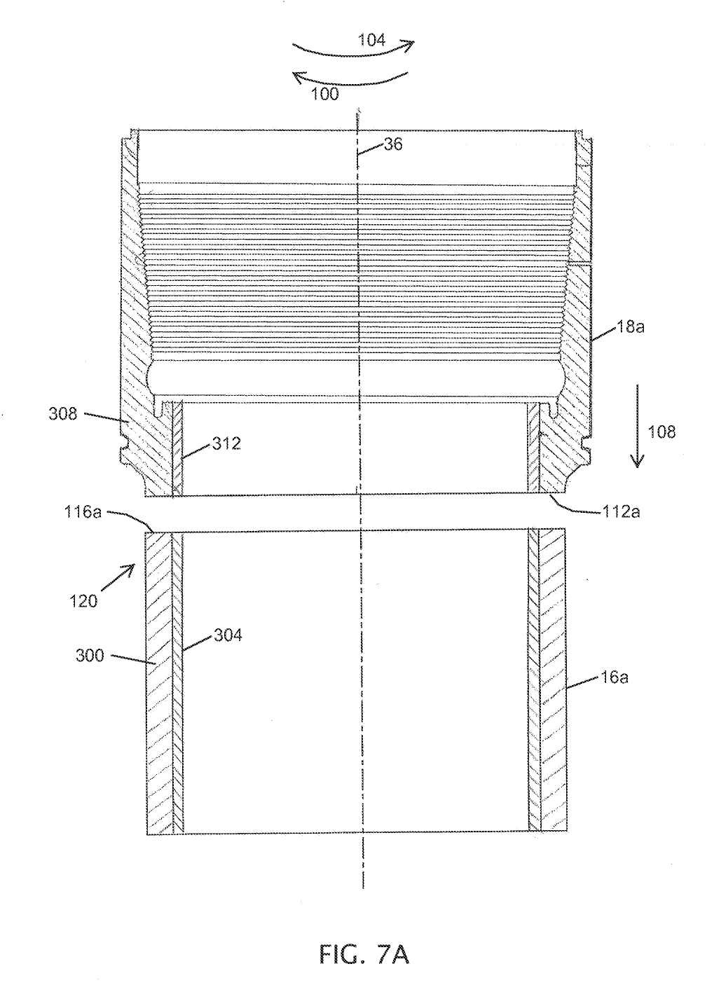

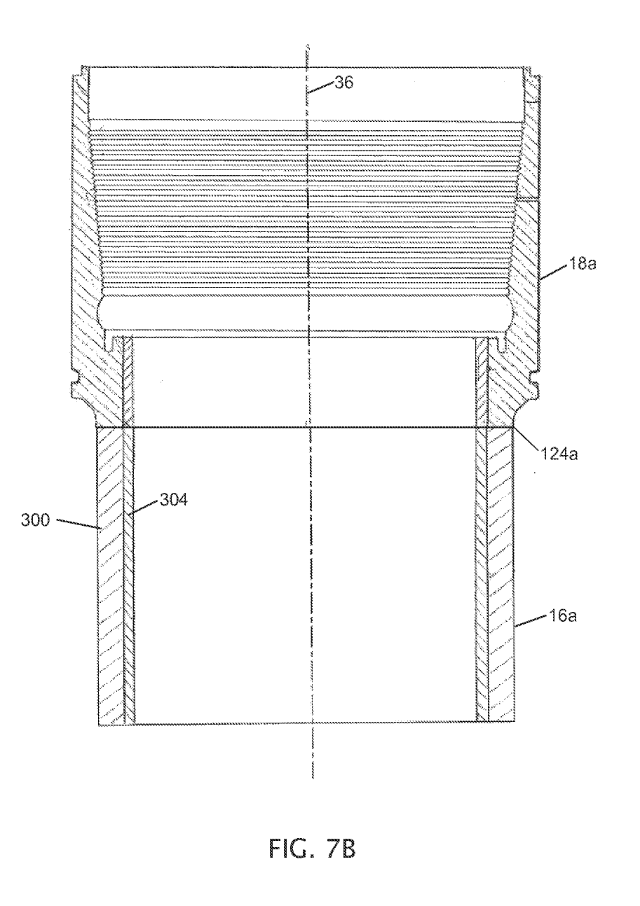

FIGS. 7A-7B depict a cross-sectional view of a second embodiment of a cladded female connector 18a and a segment of cladded pipe 16a, before and after having been joined by friction welding. In this embodiment, pipe segment 16a comprises a primary metal 300 and an interior of the pipe segment is clad with a layer 304 of corrosion resistant alloy (CRA) or other metal that is different than the primary metal. Primary metal 300 can, for example, comprise: steel (e.g., such as is known for various classes of pipe, such as, for example, X52, X60, X65, X70, and higher grades or pipe that may be used for marine risers and the like). Cladding layer 304 can comprise, for example, any of various corrosion resistant alloys (e.g., austenitic nickel-chromium-based superalloys, such as, for example, Inconel 600, Inconel 625, Inconel 718, Inconel 825, and/or the like). Cladding layer 304 may be mechanically and/or metallurgically coupled to primary metal 304. For example, in some embodiments, cladding layer 304 may be introduced as a tubular liner into pipe segment 16a and both pressurized and thereby expanded such that, upon removal of the pressure, the relatively more-resilient primary metal 300 of the pipe segment will contract more than and thus exert a compressive force on cladding layer 304. In such embodiments, the liner (cladding layer 304) may be seal welded to primary metal 300 on either end (e.g., first end 120) to metallurgically couple and provide a seal between the ends of the primary metal and cladding layer. In other embodiments, cladding layer 304 may be metallurgically deposited (e.g., via welding) along the entire length of the interior surface of primary metal 300. In some embodiments, the thickness of cladding layer 304 may, for example, be between 0.05 inches and 0.25 inches. In the embodiment shown, connector 18a also comprises a primary metal 308 and an interior of the connector is clad with a layer 312 of corrosion resistant alloy (CRA) or other metal. The primary metal and cladding layer of the connector may, for example, be or comprise similar materials to those of pipe segment 16a. In other embodiments, a non-clad connector (e.g., 18) may be friction welded to pipe segment 16a and the interior of the connector may be clad (e.g., via metallurgical, mechanical, or chemical deposition) after the connector is friction welded to the cladded pipe segment. In the embodiment shown, mating or faying surfaces 112a and 116a are substantially square, but may have other shapes in other embodiments, as described in more detail below.

As will be appreciated by those of ordinary skill in the art, cladding layers (304, 312) may require higher forging temperatures (e.g., 1000° C.) and pressures (e.g., 15-60 ksi) than primary metals (300, 308) such that higher temperatures and pressures may be needed for cladded pipe and/or connectors that would be needed for non-cladded pipe and/or connectors. For example, in some instances, at a temperature at which cladding layers are susceptible to bonding with one another, the primary metals may be plastic such that the force required for bonding during friction welding will primarily be governed by the properties of the cladding layers. In the embodiment shown in FIG. 7A, however, the differences in properties between the relatively stiffer (at least at welding temperatures) cladding layers and the primary metals may be advantageous in that the cladding layers will meet and tend to discourage the primary metal from flowing inwardly toward the interior of the pipe segment and connector, thereby increasing the likelihood of an uninterrupted interior cladding layer to resist corrosion of the primary metal, after friction welding is complete, as illustrated in FIG. 7B.

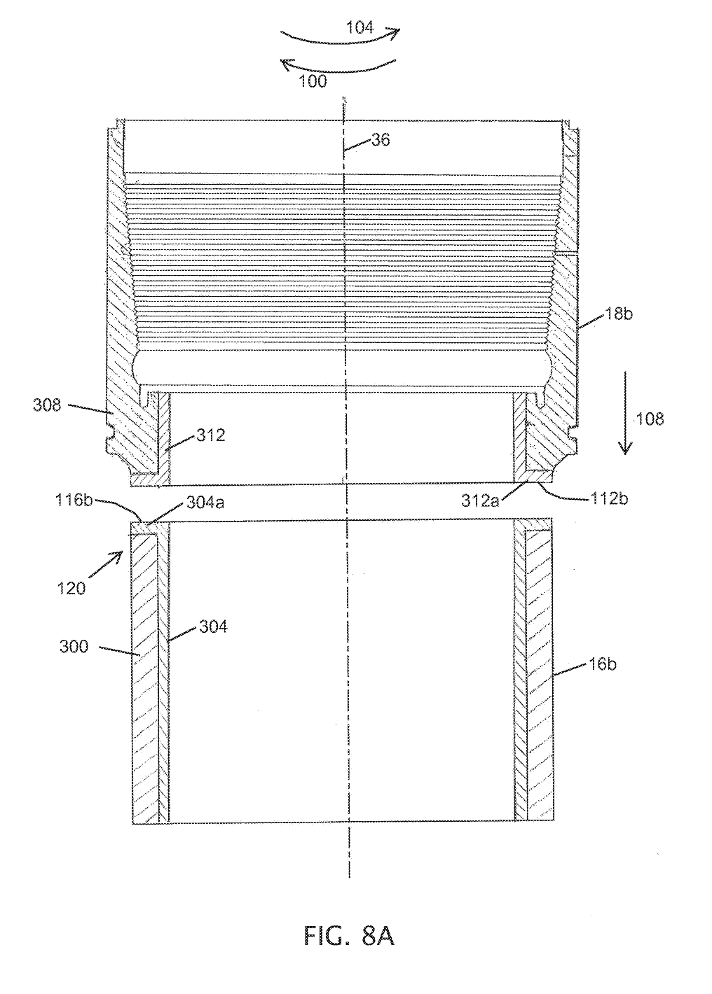

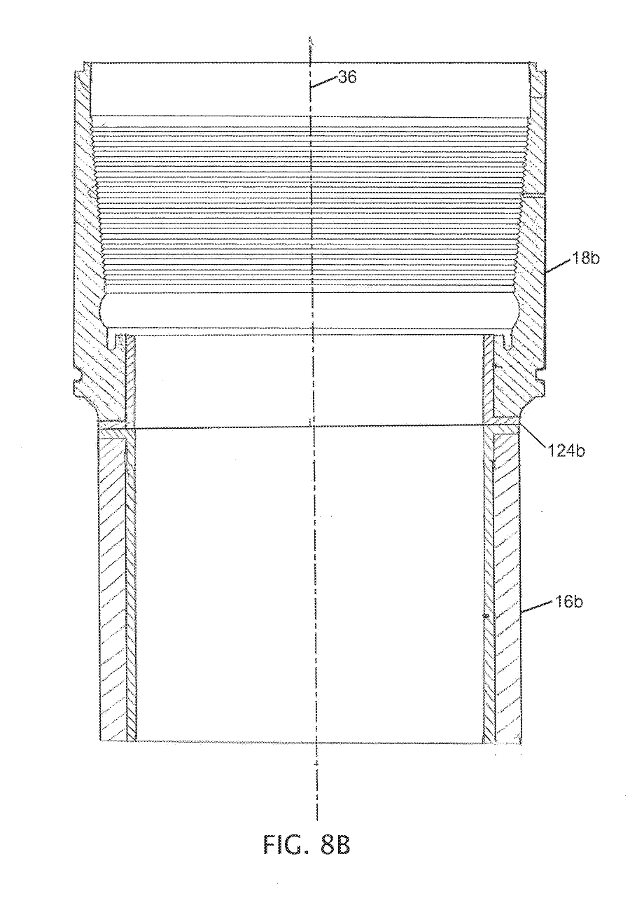

In some embodiments, due to the high temperatures that may be required to friction weld cladded pipe and/or connectors, post-weld heat treatment may be required to comply with NACE specifications which generally require the weld and heat-affected zone of a weld to be no harder than Rockwell Hardness Rc 22. However, because the present methods can be used on-shore to assemble multi joint or multi-segment lengths of pipe with mechanical connectors at either end, a requirement for heat treatment may be more tolerable than it would be in an off-shore welding environment. Further, in the present embodiments, higher-strength pipe (e.g., X125 grade pipe) may be used, which may be isolated from pipeline fluids due to the cladding and thereby reduce or eliminate the need for post-weld heat treatment. In certain other embodiments, the need for post-weld heat treatment can be reduced and/or eliminated by including a cladding layer on an end surface of the primary metal, as shown, for example, in FIGS. 8A-8B.

FIGS. 8A-8B depict a cross-sectional view of a third embodiment of a cladded female connector 18b and a segment of the second embodiment of cladded pipe 16b, before and after having been joined by friction welding. Pipe segment 16b is substantially similar to pipe segment 16a, with the exception that an end surface of the primary metal is clad with a layer 304a of corrosion resistant alloy (CRA) or other metal that is different than the primary metal. Cladding layer 304a may, for example, comprise the same material as and/or unitary with cladding layer 304. End cladding layer 304a may be provided, for example, by metallurgical deposition (e.g., at the same time that a seal weld is provided between the interior cladding layer and the primary metal or at the same time that the cladding layer is metallurgically deposited on the interior surface of primary metal, depending on the type of cladding). Similarly, connector 18b is substantially similar to connector 18a with the exception that an end surface of the primary metal is clad with a layer 312a of corrosion resistant alloy (CRA) or other metal that is different than the primary metal. Cladding layer 312a may, for example, comprise the same material as and/or unitary with cladding layer 312. End cladding layer 312a may be provided, for example, by metallurgical deposition (e.g., at the same time that a seal weld is provided between the interior cladding layer and the primary metal or at the same time that the cladding layer is metallurgically deposited on the interior surface of primary metal, depending on the type of cladding). In this embodiment, mating or faying surfaces 112b and 116b do not have the types of discontinuities that are introduced by a faying surface including both the primary metal and the cladding layer and, as such, the heat-affected zone of the resulting friction weld (as shown in FIG. 8B) may comply with NACE specifications without post-weld heat treatment. In some embodiments, the thickness of end cladding layer(s) 304a and/or 312a is between 0.25 inches and 0.5 inches.

In other embodiments, only one end surface may include an end cladding layer (304a or 312a); for example, connector 18a may be friction welded to pipe segment 16b, or connector 18b may be friction welded to pipe segment 16a. For example, in some embodiments, connector 18b may comprise a primary metal 308 that is susceptible to hardening (e.g., 4130 steel) at elevated temperatures and pressures, and can include interior and end cladding layers 312, 312a. In such embodiments, connector 18b can be friction welded to a pipe segment 16a that comprises a primary metal 300 (e.g., X60 or X65 grade pipe) that is less susceptible to hardening at elevated temperatures and pressures, and that does not include an end cladding layer, such that end cladding layer 312a of the connector will protect primary metal 308 from unacceptable hardening.

The preset methods can also be applied to rotary friction welding pipe segments (e.g., cladded pipe segments).

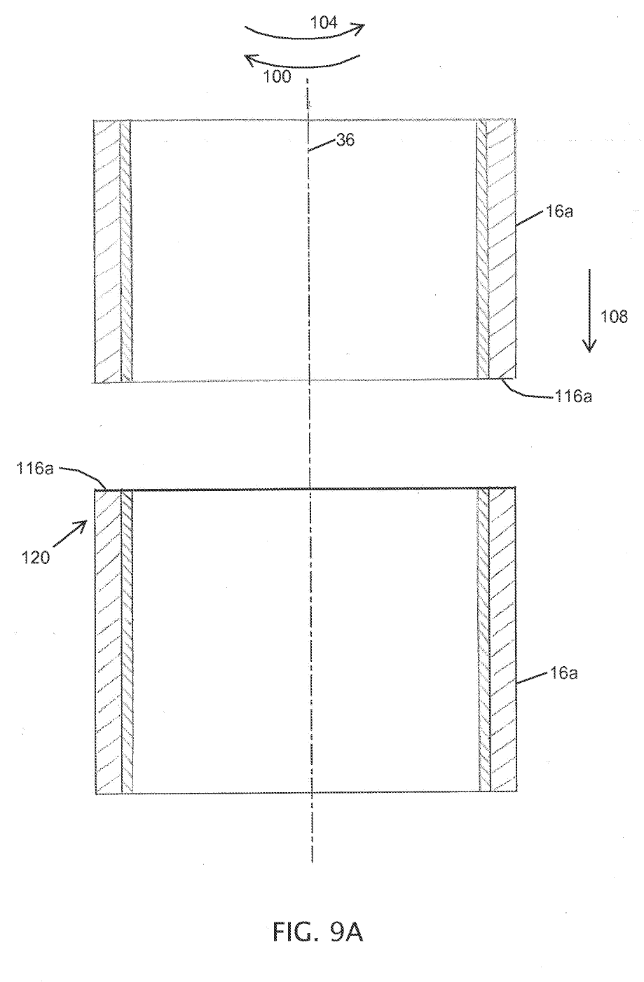

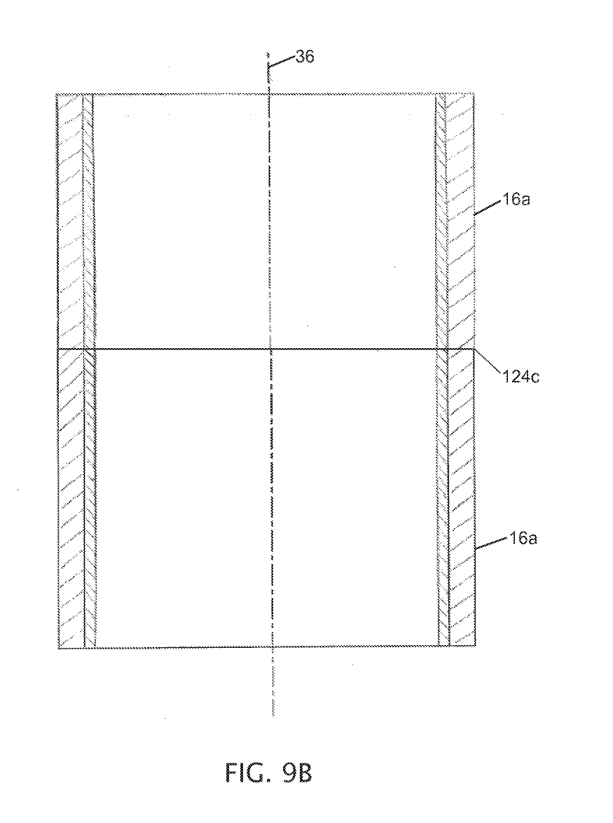

FIGS. 9A-9B, for example, depict cross-sectional views of a fourth embodiment of two segments 16a of cladded pipe, before and after having been joined by friction welding. In this embodiment, two segments 16a (as described above) are joined together by rotary friction welding.

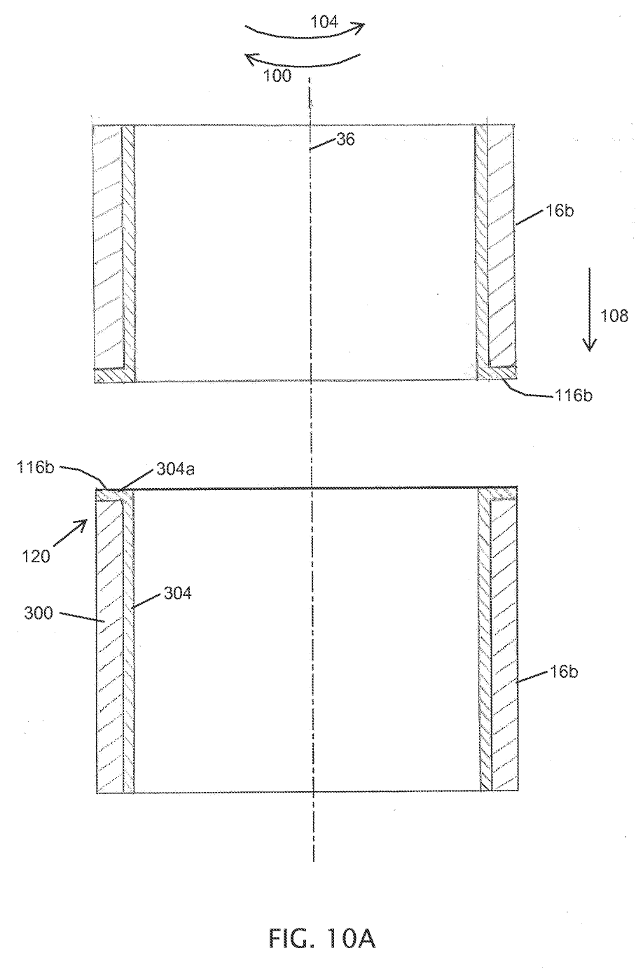

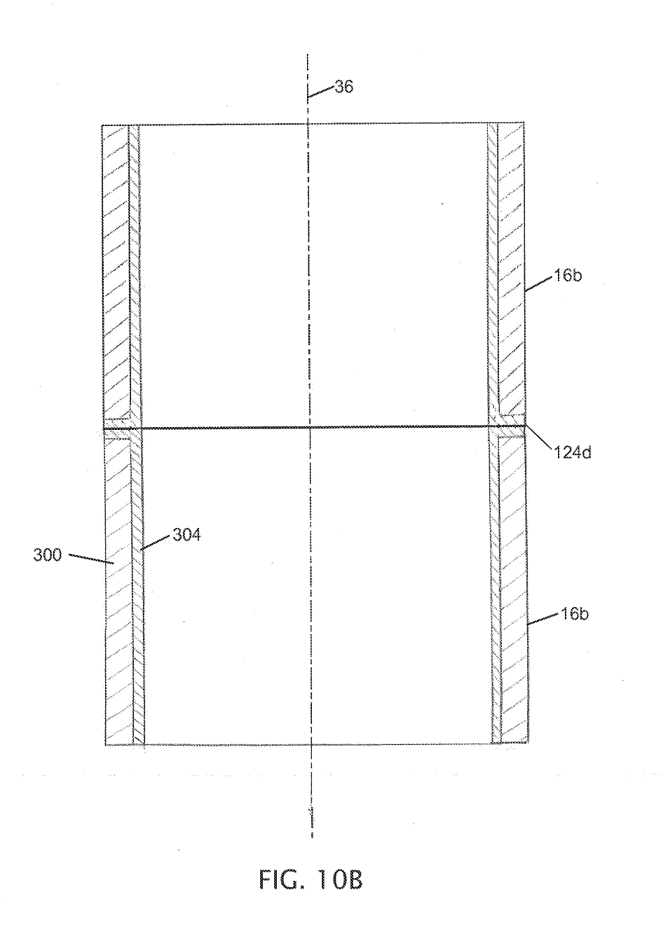

By way of further example, FIGS. 10A-10B depict cross-sectional views of a fifth embodiment of two segments 16b of cladded pipe, before and after having been joined by friction welding. In this embodiment, two segments 16b (as described above) are joined together by rotary friction welding. In other embodiments, only one end surface may include an end cladding layer (304a); for example, pipe segment 16a may be friction welded to pipe segment 16b.

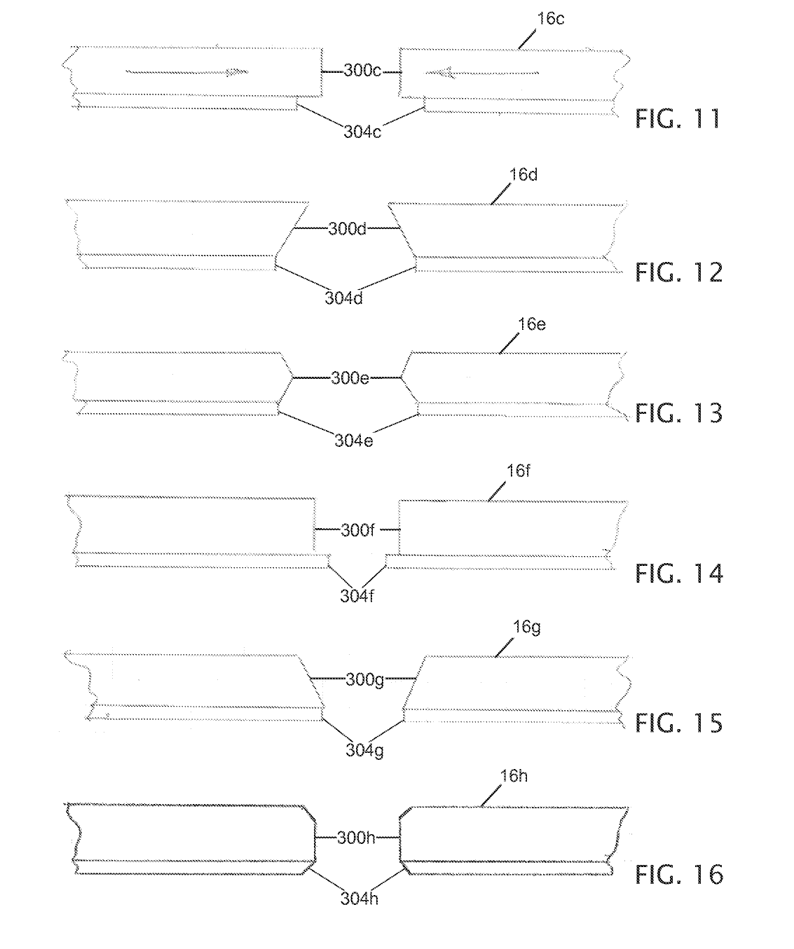

In some embodiments, a first faying surface is defined by the primary metal and interior cladding layer of the first pipe segment, a second faying surface is defined by the primary metal and interior cladding layer of the second pipe segment (or connector), and each of the first and second faying surfaces is not entirely square. FIGS. 11-15, for example, depict cutaway cross-sectional views of various configurations of faying surfaces suitable for at least some of the present embodiments. In each of the embodiments of FIGS. 11-15, two pipe segments are shown (in which the primary metals and cladding layers may be similar to any of those described above) but are equally applicable to joining a pipe segment and a connector (e.g., a cladded connector which may include any of the primary metals and/or cladding layers described above).

In the embodiment of FIG. 11, primary metal 300c extends beyond interior cladding layer 304c at the respective end profiles of each pipe segment 16c. In the embodiment of FIG. 12, primary metal 300d angles longitudinally outward and radially outward from interior cladding layer 304d at the end profile of each pipe segment 16d. In the embodiment of FIG. 13, only a portion (e.g., all) of primary metal 300e angles longitudinally outward and radially outward from interior cladding layer 304e at the end profile of each pipe segment 16e, and the remainder of primary metal 300e angles longitudinally inward and radially outward from the interior cladding layer. In each of the embodiments of FIGS. 11-13, the primary metal of the two pipe segments is configured to meet and flow together first such that the relatively stiffer (at least at welding temperatures) cladding layers can come together to pinch off excess primary metal at the interior of the pipe.

Other embodiments are configured for the cladding layers to meet first. For example, in the embodiment of FIG. 14, interior cladding layer 304f extends beyond primary metal 300f at the end profile of each pipe segment 16f. In the embodiment of FIG. 15, primary metal 300g angles longitudinally inward and radially outward from interior cladding layer 304g at the end profiles of pipe segments 16g. In each of the embodiments of FIGS. 14 and 15, the end profiles of the pipe segments are configured such that the cladding layers will meet and tend to discourage the primary metal from flowing inwardly toward the interior of the pipe segment and connector, thereby increasing the likelihood of an uninterrupted interior cladding layer to resist corrosion of the primary metal.

FIG. 16 an additional embodiment depicting a chamfer feature that can be applied to inner and/or outer edges of the faying surfaces any of the present cladded and/or non-cladded pipe segments and/or connectors (e.g., 16, 16a, 16b, 18, 18a, 18b, etc.). In the embodiment shown, the inner and outer edges of the faying surfaces (defined by both primary metal 300h and cladding 304h) of pipe segment 16h are chamfered by a distance of approximately 1/16 of an inch. In other embodiments, the inner edge and/or the outer edge can be chamfered by any suitable distance (e.g., equal to any one of or between any two of: 1/16 of an inch, ⅛ of an inch, and/or ¼ of an inch). For example, in some embodiments, only the inner edge is chamfered, only the outer edge is chamfered, or both the inner and outer edges are chamfered but by different distances (e.g., inner edge chamfered by 1/16 of an inch and outer edge chamfered by ¼ of an inch). In such chamfered embodiments, the chamfered portion can reduce the amount of flash that is extruded from the inner and outer edges, and thereby reduce amount of machining that may be required after the friction welding process is completed.

FIG. 17 depicts a cutaway cross-sectional view of a friction weld after joining and under an axial load while still hot to allow machining to remove excess material. In some embodiments, the weld is configured and performed such that an extruded flash 316 on an interior of the pipe after friction welding has a hardness of less than Rockwell Hardness Rc 30, which may act as a ceiling above which certain machining methods and tools may be less effective. Machining at or below this hardness value may be achieved by machining while the friction welded joint is still at an elevated (relative to ambient) temperature and/or while the friction-welded joint is still under an axial load. In other embodiments, the materials and/or cooling profile are configured such that the interior extruded flash or “ram's horn” has a hardness of less than Rockwell Hardness Rc 30 after the removal of the axial load and after being cooled to ambient temperature.

The above specification and examples provide a description of the structure and use of exemplary embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the present devices are not intended to be limited to the particular forms disclosed. Rather, they include all modifications and alternatives falling within the scope of the claims, and embodiments other than the one shown may include some or all of the features of the depicted embodiment. For example, components may be combined as a unitary structure. Further, where appropriate, aspects of any of the examples described above may be combined with aspects of any of the other examples described to form further examples having comparable or different properties and addressing the same or different problems. Similarly, it will be understood that the benefits and advantages described above may relate to one embodiment or may relate to several embodiments.

The claims are not intended to include, and should not be interpreted to include, means-plus- or step-plus-function limitations, unless such a limitation is explicitly recited in a given claim using the phrase(s) “means for” or “step for,” respectively.

1. A method comprising:
rotary friction welding a threaded first connector to an undersea-type riser or flowline pipe segment.

2. The method of claim 1, where the rotary friction welding comprises:
rotating the first connector in contact with the pipe segment until a portion of the first connector reaches a plastic state and a portion of the pipe segment reaches a plastic state; and
pressing the first connector and the pipe segment together until the first connector and pipe segment have fused together.

3. The method of claim 2, where the connector and the pipe segment are pressed together at a pressure of between 14,000 pounds per square inch (psi) and 60,000 psi.

4. The method of claim 3, where portions of the connector and the pipe segment reach temperatures of between 900° C. and 1100° C. during the rotary friction welding.

5. The method of claim 2, where at least a portion of the pressing is simultaneous with at least a portion of the rotating.

6. The method of claim 1, where the first connector is concentrically threaded.

7. The method of claim 1, where the first connector is configured to be joined with a second connector by forcing the first and second connectors together without rotation along a common longitudinal axis.

8. The method of claim 1, where the first connector includes an annular pipe mating surface, and the pipe includes an annular connector mating surface configured to mate with the pipe mating surface of the first connector.

9. The method of claim 1, where the pipe has an outer diameter of 6 inches or greater.

10. The method of claim 9, where the pipe has an outer diameter of 8 inches or greater.

11. The method of claim 10, where the pipe has an outer diameter of 12 inches or greater.

12. The method of claim 1, where during the rotary friction welding, rotation of the connector is driven by a powered motor.

13. The method of claim 1, where during the rotary friction welding, the connector is driven by the inertia of a flywheel.

14. The method of claim 13, where the rotary friction welding comprises:
applying a force to accelerate the flywheel to a velocity at which the flywheel has sufficient kinetic energy to rotate the first connector to fuse the connector to the pipe;
removing the force from the flywheel; and
pressing the connector and the pipe together as the connector is rotated by the flywheel until the rotation stops and the connector is fused to the pipe.

15. The method of any of claims 1-12, where the pipe segment comprises a primary metal and an interior of the pipe segment is clad with a layer of corrosion resistant alloy (CRA) or other metal that is different than the primary metal.

16. The method of claim 15, where the interior cladding layer is mechanically coupled to the primary metal.

17. The method of any of claims 15-16, where the interior cladding layer is metallurgically coupled to the primary metal.

18. The method of any of claims 15-17, where a thickness of the interior cladding layer of the pipe segment is between 0.05 inches and 0.25 inches.

19. The method of claim 15, where the connector comprises a primary metal and an interior of the connector is clad with a layer of corrosion resistant alloy (CRA) or other metal.

20. The method of claim 15, where an extruded flash on an interior of the pipe after friction welding has a hardness of less than Rockwell Hardness Rc 30.

21. The method of claim 15, where an end surface of the primary metal is clad with a layer of corrosion resistant alloy (CRA) or other metal that is different than the primary metal.

22. The method of claim 21, where the thickness of the end cladding layer is between 0.25 inches and 0.5 inches.

23. The method of claim 15, where a first faying surface is defined by the primary metal and interior cladding layer of the pipe segment, and the first faying surface is not entirely square.

24. The method of claim 23, where the primary metal extends beyond the interior cladding layer at an end profile of the pipe segment.

25. The method of claim 23, where the interior cladding layer extends beyond the primary metal at an end profile of the pipe segment.

26. The method of claim 23, where at least a portion of the primary metal angles longitudinally outward and radially outward from the interior cladding layer at an end profile of the pipe segment.

27. The method of claim 26, where a portion of the primary metal angles longitudinally inward and radially outward from the interior cladding layer at an end profile of the pipe segment.

28. The method of claim 26, where the primary metal angles longitudinally inward and radially outward from the interior cladding layer at an end profile of the pipe segment.

29. The method of claim 15, further comprising:
rotary friction welding a second undersea-type riser or flowline pipe segment to the first pipe segment;
where the second pipe segment comprises a primary metal and an interior of the second pipe segment is clad with a layer of corrosion resistant alloy (CRA) or other metal that is different than the primary metal.

30. The method of claim 29, further comprising:
rotary friction welding a threaded second connector to the second pipe segment.

31. The method of claim 29, further comprising:
rotary friction welding a third undersea-type riser or flowline pipe segment to the second pipe segment;
where the second pipe segment comprises a primary metal and an interior of the third pipe segment is clad with a layer of corrosion resistant alloy (CRA) or other metal that is different than the primary metal.

32. The method of claim 31, further comprising:
rotary friction welding a threaded second connector to the third pipe segment.

33. The method of claim 31, further comprising:
rotary friction welding a fourth undersea-type riser or flowline pipe segment to the third pipe segment;
where the fourth pipe segment comprises a primary metal and an interior of the fourth pipe segment is clad with a layer of corrosion resistant alloy (CRA) or other metal that is different than the primary metal.

34. The method of claim 33, further comprising:
rotary friction welding a threaded second connector to the fourth pipe segment.

35. The method of any of claims 29-34, where the rotary friction welding occurs on-shore before shipping the assembly to an off-shore location.

36. An apparatus comprising:
a length of undersea-type riser or flowline pipe having a first end;
a threaded connector fused to the first end at an autogeneous friction welded seam.

37. The apparatus of claim 36, where the first connector is concentrically threaded.

38. The apparatus of claim 36, where the first connector is configured to be joined with a second connector by forcing the first and second connectors together without rotation along a common longitudinal axis.

39. The apparatus of claim 36, where the pipe has an outer diameter of 6 inches or greater.

40. The apparatus of claim 39, where the pipe has an outer diameter of 8 inches or greater.

41. The apparatus of claim 40, where the pipe has an outer diameter of 12 inches or greater.

42. The apparatus of any of claims 13-18, where the pipe segment comprises a primary metal and an interior of the pipe segment is clad with a layer of corrosion resistant alloy (CRA) or other metal that is different than the primary metal.

43. The apparatus of claim 42, where the interior cladding layer is mechanically coupled to the primary metal.

44. The apparatus of any of claims 42-43, where the interior cladding layer is metallurgically coupled to the primary metal.

45. The apparatus of any of claims 42-44, where a thickness of the interior cladding layer of the pipe segment is between 0.05 inches and 0.25 inches.

46. The apparatus of claim 42, where the connector comprises a primary metal and an interior of the connector is clad with a layer of corrosion resistant alloy (CRA) or other metal.

47. The apparatus of claim 42, where the friction weld comprises a corrosion resistant alloy (CRA) or other metal that is different than the primary metal.

48. The apparatus of claim 42, further comprising:
a second undersea-type riser or flowline pipe segment fused to the first pipe segment fused at an autogeneous friction welded seam;
where the second pipe segment comprises a primary metal and an interior of the second pipe segment is clad with a layer of corrosion resistant alloy (CRA) or other metal that is different than the primary metal.

49. The apparatus of claim 48, further comprising:
a threaded second connector fused to the second pipe segment at an autogeneous friction welded seam.

50. The apparatus of claim 48, further comprising:
a third undersea-type riser or flowline pipe segment fused to the second pipe segment fused at an autogeneous friction welded seam;
where the third pipe segment comprises a primary metal and an interior of the second pipe segment is clad with a layer of corrosion resistant alloy (CRA) or other metal that is different than the primary metal.

51. The apparatus of claim 50, further comprising:
a threaded second connector fused to the third pipe segment at an autogeneous friction welded seam.

52. The apparatus of claim 50, further comprising:
a fourth undersea-type riser or flowline pipe segment fused to the second pipe segment fused at an autogeneous friction welded seam;
where the fourth pipe segment comprises a primary metal and an interior of the second pipe segment is clad with a layer of corrosion resistant alloy (CRA) or other metal that is different than the primary metal.

53. The apparatus of claim 52, further comprising:
a threaded second connector fused to the fourth pipe segment at an autogeneous friction welded seam.

54. A method comprising:
rotary friction welding a first and second undersea-type riser or flowline pipe segments together;
where each of the first and second pipe segments comprises a primary metal and an interior of the respective pipe segment is clad with a layer of corrosion resistant alloy (CRA) or other metal that is different than the primary metal.

55. The method of claim 54, where the interior cladding layer of at least one of the first and second pipe segments is mechanically coupled to the primary metal.

56. The method of any of claims 54-55, where the interior cladding layer of at least one of the first and second pipe segments is metallurgically coupled to the primary metal.

57. The method of any of claims 55-56, where a thickness of the interior cladding layer of the pipe segment is between 0.05 inches and 0.25 inches.

58. The method of claim 55, where an extruded flash on an interior of the pipe after friction welding has a hardness of less than Rockwell Hardness Rc 30.

59. The method of claim 55, where an end surface of the primary metal of at least one of the first and second pipe segments is clad with a layer of corrosion resistant alloy (CRA) or other metal that is different than the primary metal.

60. The method of claim 59, where the thickness of the end cladding layer is between 0.25 inches and 0.5 inches.

61. The method of claim 59, where a first faying surface is defined by the primary metal and interior cladding layer of the first pipe segment, a second faying surface is defined by the primary metal and interior cladding layer of the second pipe segment, and each of the first and second faying surfaces is not entirely square.

62. The method of claim 61, where the primary metal extends beyond the interior cladding layer at an end profile of each of the first and second pipe segment.

63. The method of claim 61, where the interior cladding layer extends beyond the primary metal at an end profile of each of the first and second pipe segments.

64. The method of claim 61, where at least a portion of the primary metal angles longitudinally outward and radially outward from the interior cladding layer at an end profile of each of the first and second pipe segments.

65. The method of claim 64, where a portion of the primary metal angles longitudinally inward and radially outward from the interior cladding layer at an end profile of each of the first and second pipe segments.

66. The method of claim 64, where the primary metal angles longitudinally inward and radially outward from the interior cladding layer at an end profile of the pipe segment.

67. The method of claim 54, where the rotary friction welding comprises:
rotating the first pipe segment in contact with the second pipe segment until portions of the first and second pipe segments reach a plastic state; and
pressing the first and second pipe segments together until the first and second pipe segments have fused together.

68. The method of claim 67, where the first and second pipe segments are pressed together at a pressure of between 14,000 pounds per square inch (psi) and 60,000 psi.

69. The method of claim 54, where portions of the connector and the pipe segment reach temperatures of between 900° C. and 1100° C. during the rotary friction welding.

70. The method of claim 67, where at least a portion of the pressing is simultaneous with at least a portion of the rotating.

71. The method of claim 54, where the first and second pipe segments each has an outer diameter of 6 inches or greater.

72. The method of claim 71, where the first and second pipe segments each has an outer diameter of 8 inches or greater.

73. The method of claim 72, where the first and second pipe segments each has an outer diameter of 12 inches or greater.

74. The method of claim 54, where during the rotary friction welding, rotation of the first pipe segment is driven by a powered motor.

75. The method of claim 54, where during the rotary friction welding, rotation of the first pipe segment is driven by the inertia of a flywheel.

76. The method of claim 75, where the rotary friction welding comprises:
applying a force to accelerate the flywheel to a velocity at which the flywheel has sufficient kinetic energy to rotate the first connector to fuse the first pipe segment to the second pipe segment;
removing the force from the flywheel; and
pressing the first and second pipe segments together as the first pipe segment is rotated by the flywheel until the rotation stops and the first and second pipe segments are fused together.

77. An apparatus comprising:
a first segment of undersea-type riser or flowline pipe having a first end;
a second segment of undersea-type riser or flowline pipe having a first end;
a threaded connector fused to the first end at an autogeneous friction welded seam.

78. The apparatus of claim 77, where the first and second pipe segments each has an outer diameter of 6 inches or greater.

79. The apparatus of claim 78, where the first and second pipe segments each has an outer diameter of 8 inches or greater.

80. The apparatus of claim 79, where the first and second pipe segments each has an outer diameter of 12 inches or greater.

81. The apparatus of any of claims 13-18, where each of the first and second pipe segments comprises a primary metal and an interior of the respective pipe segment is clad with a layer of corrosion resistant alloy (CRA) or other metal that is different than the primary metal.

82. The apparatus of claim 81, where the interior cladding layer of each of the first and second pipe segments is mechanically coupled to the primary metal.

83. The apparatus of any of claims 81-82, where the interior cladding layer of each of the first and second pipe segments is metallurgically coupled to the primary metal.

84. The apparatus of any of claims 81-83, where a thickness of the interior cladding layer of each of the first and second pipe segments is between 0.05 inches and 0.25 inches.

85. The method of claim 61, where the friction weld comprises a corrosion resistant alloy (CRA) or other metal that is different than the primary metal.
